(19) United States
(12) Patent Application Publication
(10) Pub. No.: US 2026/0326821 A1
(43) Pub. Date: Oct. 22, 2026

(54) High-Durability Pressure-Monitoring Steering System for Vehicle Chassis

(71) Applicant: Chang Chia Cheng, Taiching City (TW)

(72) Inventor: Chang Chia Cheng, Taiching City (TW)

(21) Appl. No.: 19/184,131

(22) Filed: Apr. 21, 2025

(51) Int. Cl. B62D 15/02; B62D 7/16

(52) U.S. Cl. CPC B62D 15/029; B62D 7/16

(57) ABSTRACT

The present invention relates to a high-durability and clearance-monitoring steering component for vehicle chassis applications. The inner bushing (Reference No. 16) is made of a composite material comprising POK and glass fiber, offering high wear resistance and long service life. When wear occurs at the junction between the inner bushing and the ball pin (Reference No. 18), a clearance-monitoring device provides a warning. The device includes two types: Type A (warning via pin ejection) and Type B (warning via pin retraction), and is capable of transmitting electronic signals to a vehicle electronic control unit (ECU). The present invention is applicable to various types of vehicles, including passenger cars, commercial vehicles, trucks, military vehicles, electric vehicles, and construction vehicles, and is also suitable for Steer-By-Wire (SBW) systems.

### TECHNICAL FIELD

The present invention relates to a high-durability and clearance monitoring steering component for a vehicle chassis, particularly a structure involving a bushing and a ball joint that incorporates a pressure sensing mechanism, providing both mechanical and electronic warning functions. It is applicable to various types of vehicles equipped with wheels and steering systems, including but not limited to passenger vehicles, commercial vehicles, trucks, military vehicles, electric vehicles, construction vehicles, and forklifts, and may also be extended to Steer-By-Wire (SBW) steering systems.

### BACKGROUND ART

In the current aftermarket, part replacement is often determined by technician experience without objective criteria or real-time monitoring tools.

Most current vehicle chassis components on the market, such as tie rod ends, ball joints, and control arms, generally use fully enclosed bushings made of Nylon or POM. After long-term use, these materials are prone to wear, and they lack mechanisms for immediate warning when looseness or clearance occurs, potentially resulting in vehicle noise, instability in handling, or even component failure. Users typically rely on experience or visual inspection during maintenance to determine whether replacement is necessary, which lacks scientific and real-time assessment.

### DISCLOSURE OF THE INVENTION

To solve the aforementioned problems, this invention provides a steering component with a high-durability bushing and clearance monitoring functionality. The features are as follows:

A bushing (Part No. 16) composed of left, right, and upper bushing sections. The left and right bushings are fixed in structure and made of a composite material consisting of POK and fiberglass, offering excellent wear resistance and long-term stability. The upper bushing is designed to sink downward; when the lower inner edges of the bushing and the shaft (Ball Pin, Part No. 18) experience friction and wear after long-term use, the upper bushing sinks along with the shaft, thereby generating a clearance that activates the warning mechanism.

An elastic element (Part No. 13B, or 13C for the B-type) is installed between the bushing and the outer housing to provide a pressure-driving force. When wear occurs, the elastic element pushes the upper bushing downward, thereby engaging the warning device.

This invention includes two structural types of clearance monitoring mechanisms:
(1) Type A structure: Utilizes a convex upper cover (Part No. 15A) and a plunger pin (Part No. 9A). When clearance occurs, the plunger pin is pushed upward by the elastic element (Part No. 13A), causing the plastic housing (Part No. 10A) to expose a color, serving as a mechanical visual warning. When combined with metallic sensing elements (Part No. 11A or 11B), electronic signals can be transmitted to the ECU. The assembly further includes a plastic washer (Part No. 12) and a metal fixing screw (Part No. 14) for insulation and fixation purposes.
(2) Type B structure: Utilizes a slightly convex or flat upper cover (Part No. 15B) and a recessed plunger pin (Part No. 9B), which is integrated with the plastic housing (Part No. 10B).

When clearance occurs, the entire structure sinks, and the fixing screw (Part No. 20) exposes a color through its inner hole for visual warning. When used with a sensing metal (Part No. 11C), electronic signals may also be generated. The B-type elastic element is identified as Part No. 13C, responsible for pushing the upper bushing downward. This structure does not include Parts No. 12 and 14.

The A-type and B-type structures introduced in this invention are novel configurations. Any design using vertical displacement of the plunger pin (Parts No. 9A or 9B), whether by outward ejection or inward retraction, that triggers visual color alerts or electronic signal transmission shall fall within the scope of this invention. Even if the shape, cover style, or sensing method differs, such modifications cannot circumvent the core protection of this patent.

The applicable component names for this invention include, but are not limited to: tie rod end, ball joint, control arm, stabilizer link, side rod assembly, idler arm, pitman arm, center link, cross rod, and drag link. The terms “center link,” “cross rod,” and “drag link” are merely naming variations for different vehicle models; their structure and function are the same and are all protected under this invention.

In addition, the extended service life of the present invention reduces unnecessary part replacements, contributing to environmental sustainability and material conservation.

### Supplementary Explanation of Structural Principles

Regardless of the chassis component to which this invention is applied, its core is centered around the ball joint, forming a pressure conversion and sensing system composed of the bushing (Part No. 16) and the shaft (Part No. 18). This system utilizes structural differences between the upper and lower bushing sections in combination with an elastic element. When wear occurs, structural displacement triggers the warning mechanism, providing both mechanical and electronic alerts. This universal design logic is the core of the invention, and any design that conforms to this logic shall be protected under the scope of the patent.

### BRIEF DESCRIPTION OF DRAWINGS

FIG. 1: Diagram of vehicle chassis structure and installation position of the invention.

FIG. 2A: Diagram of traditional fully enclosed bushing structure (without monitoring device).

FIG. 2B: Diagram of Type A bushing structure and clearance monitoring mechanism.

FIG. 2C: Diagram of Type B bushing structure and clearance monitoring mechanism.

FIG. 3A: Exploded view of Type A product.

FIG. 3B: Assembled view of Type A product.

FIG. 3C: Exploded view of Type B product.

FIG. 3D: Assembled view of Type B product.

FIG. 4A: Diagram of Type A product under normal conditions with no clearance.

FIG. 4B: Mechanical warning diagram of Type A product (plunger pin ejected).

FIG. 4C: Electronic warning diagram of Type A product (connected to ECU).

FIG. 4D: Diagram of Type B product under normal conditions with no clearance.

FIG. 4E: Mechanical warning diagram of Type B product (plunger pin retracted).

FIG. 4F: Electronic warning diagram of Type B product (connected to ECU).

FIG. 5A-5P: Comparative diagrams of market conventional designs and invention designs corresponding to Part Nos. 1 through 8 in FIG. 1 (all shown with ball joint structures).

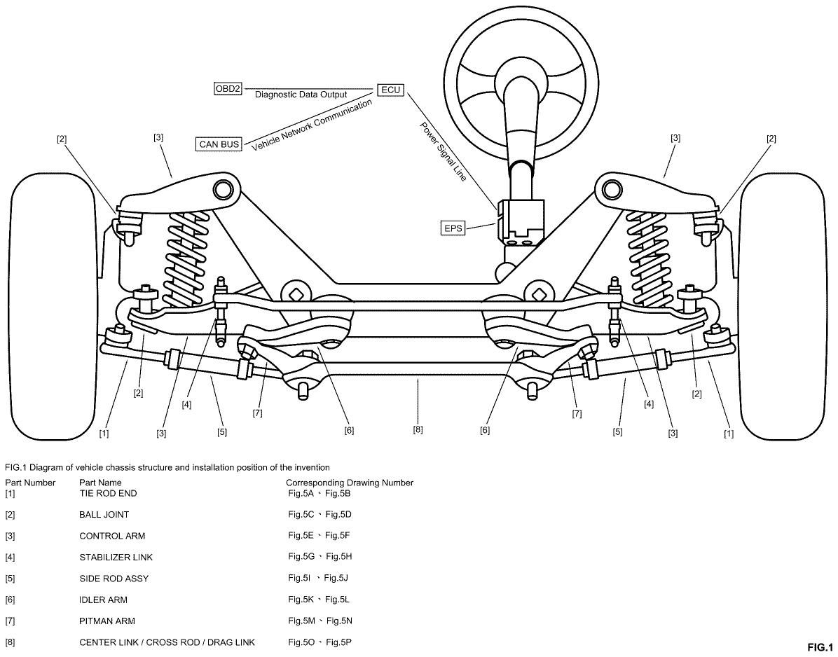

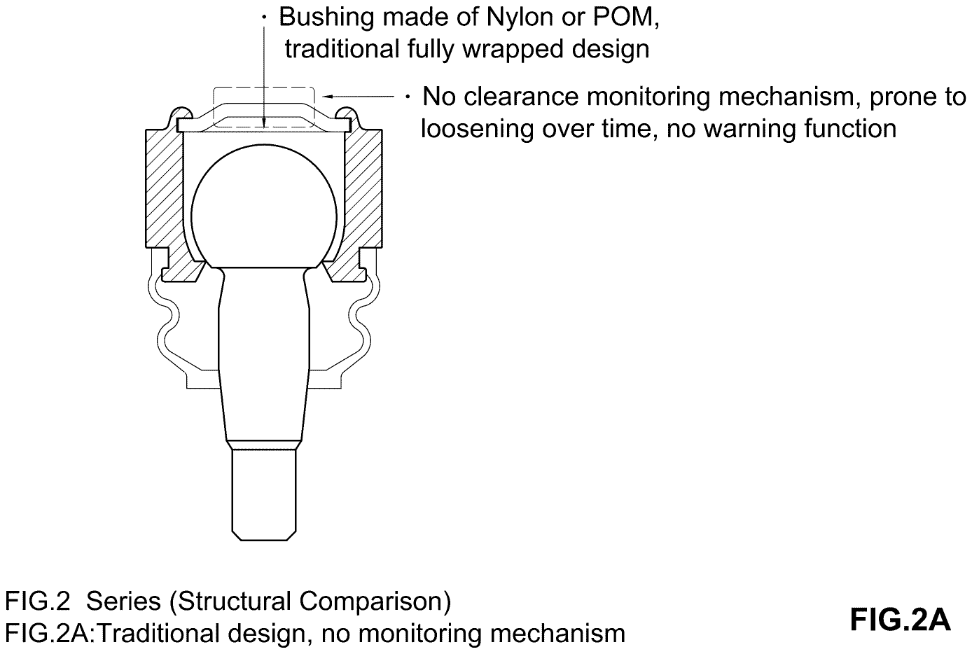

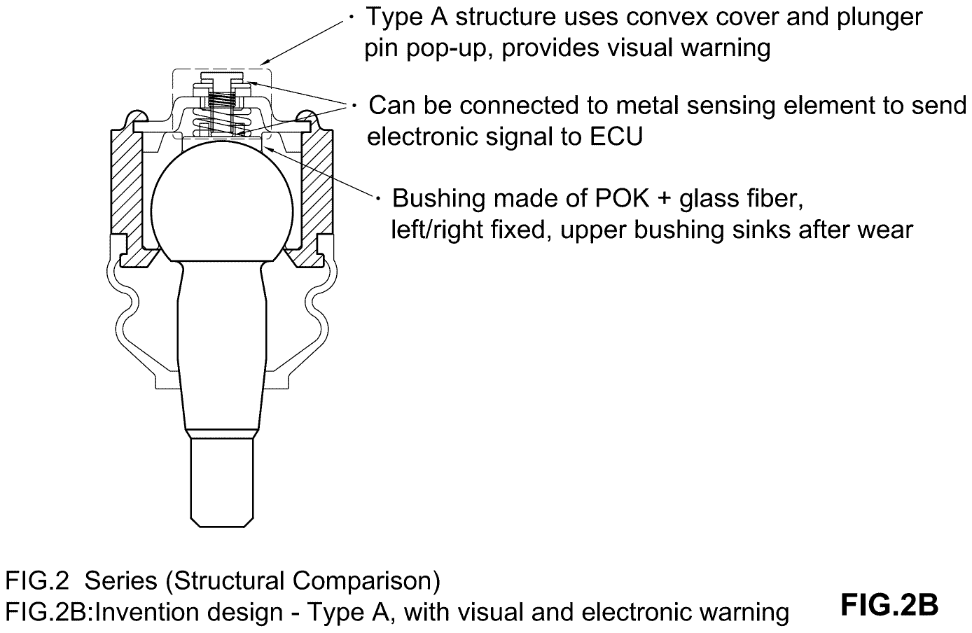

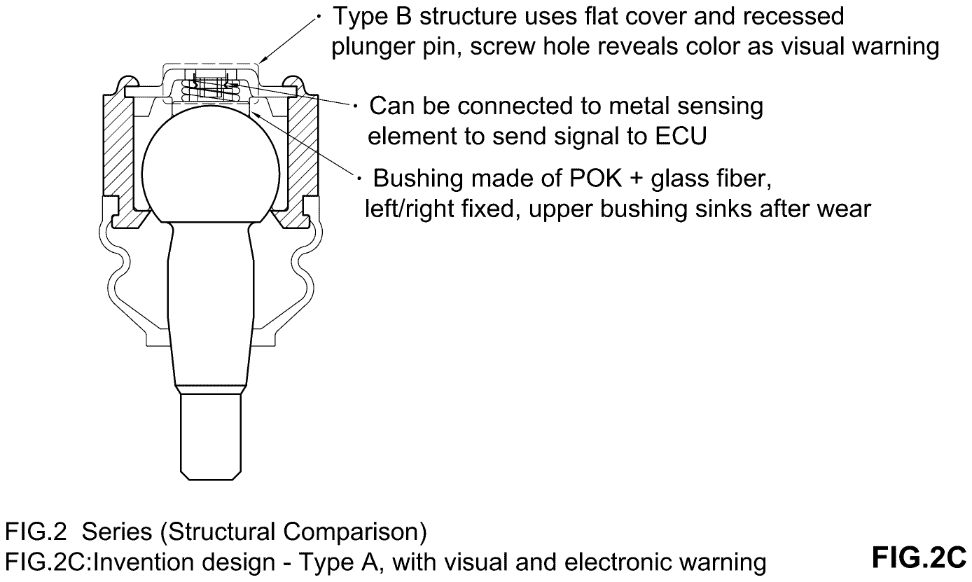

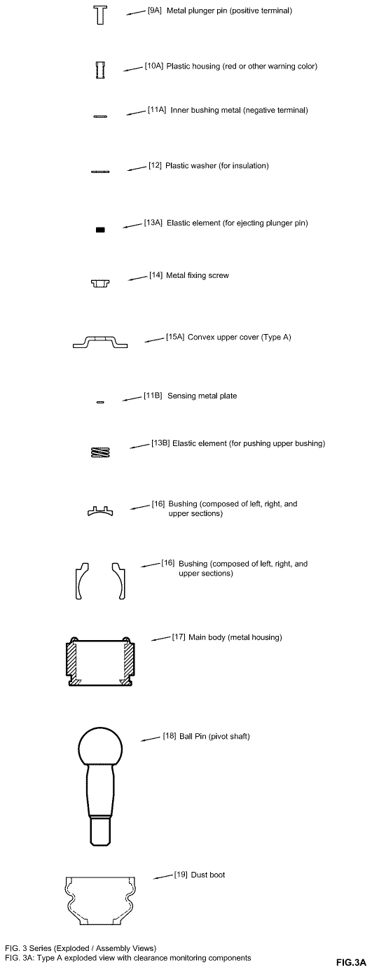

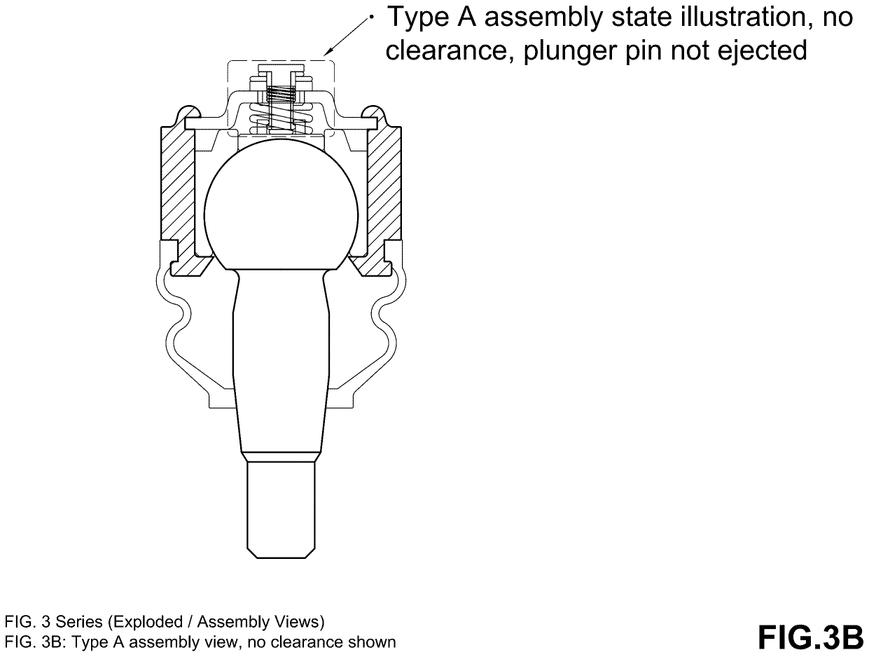

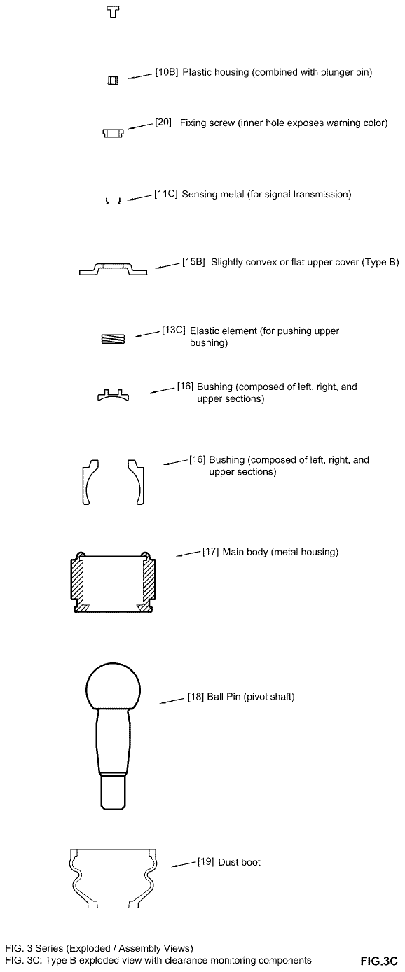

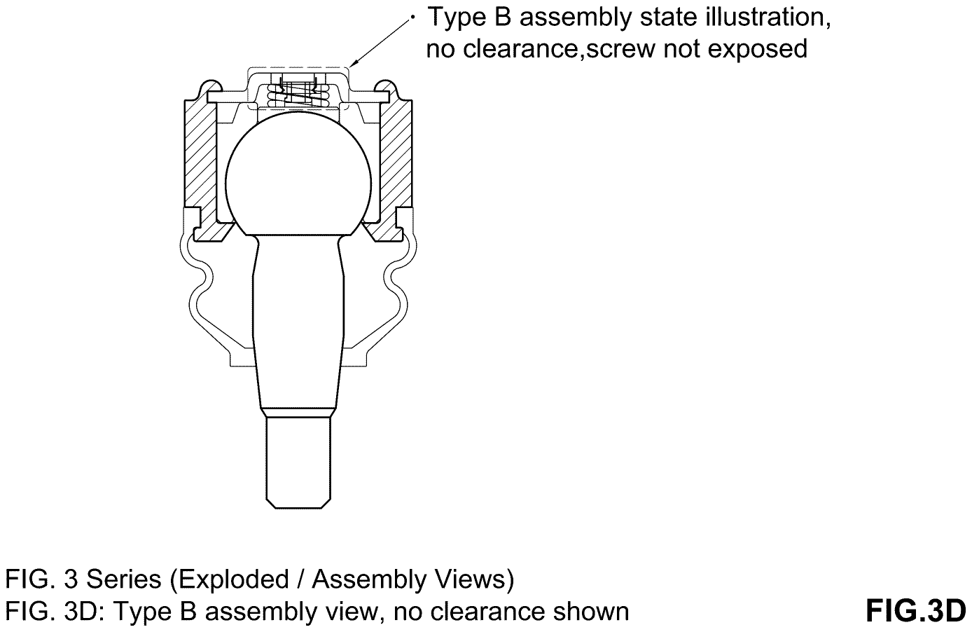

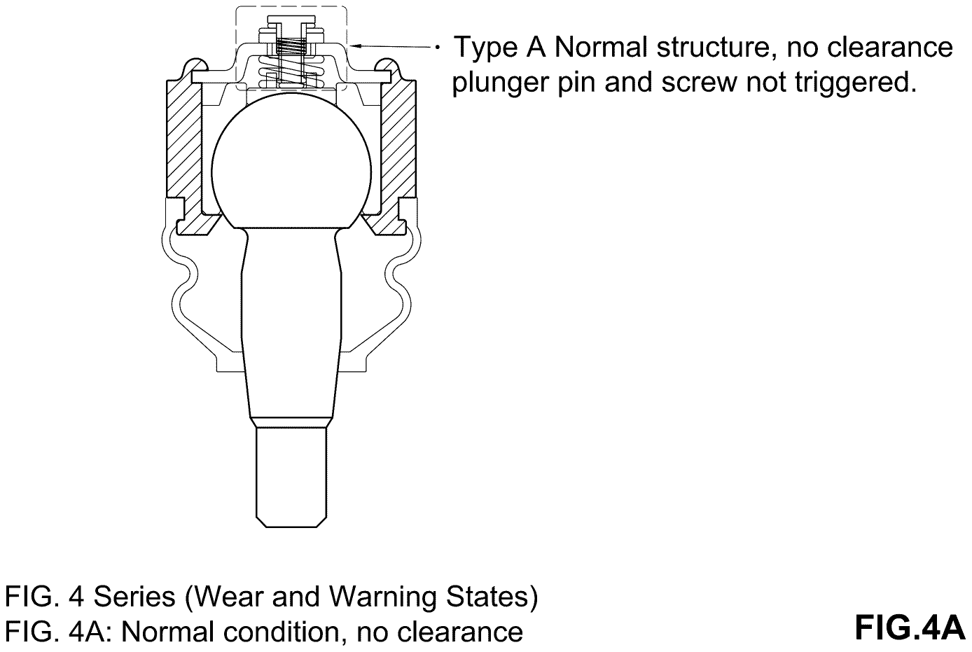

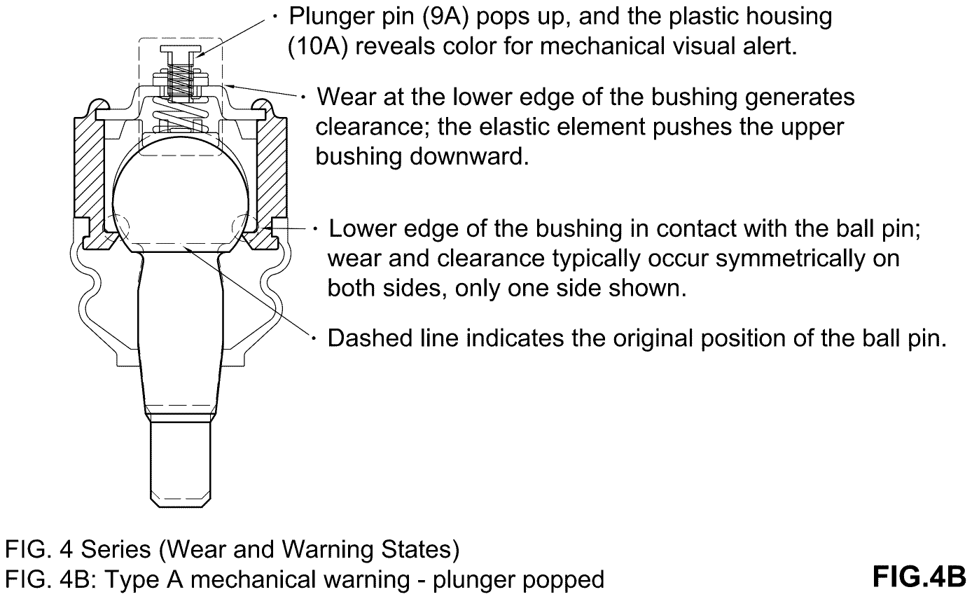

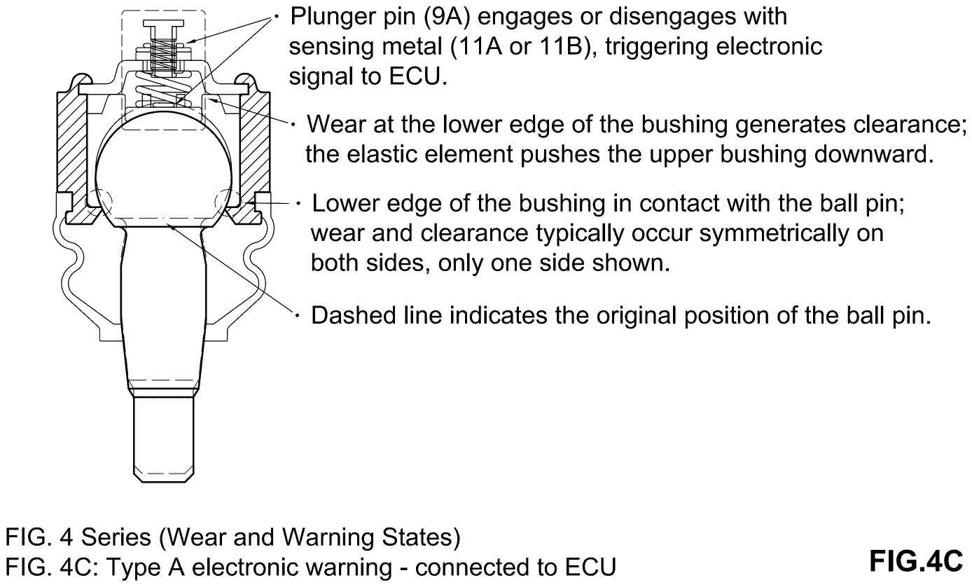

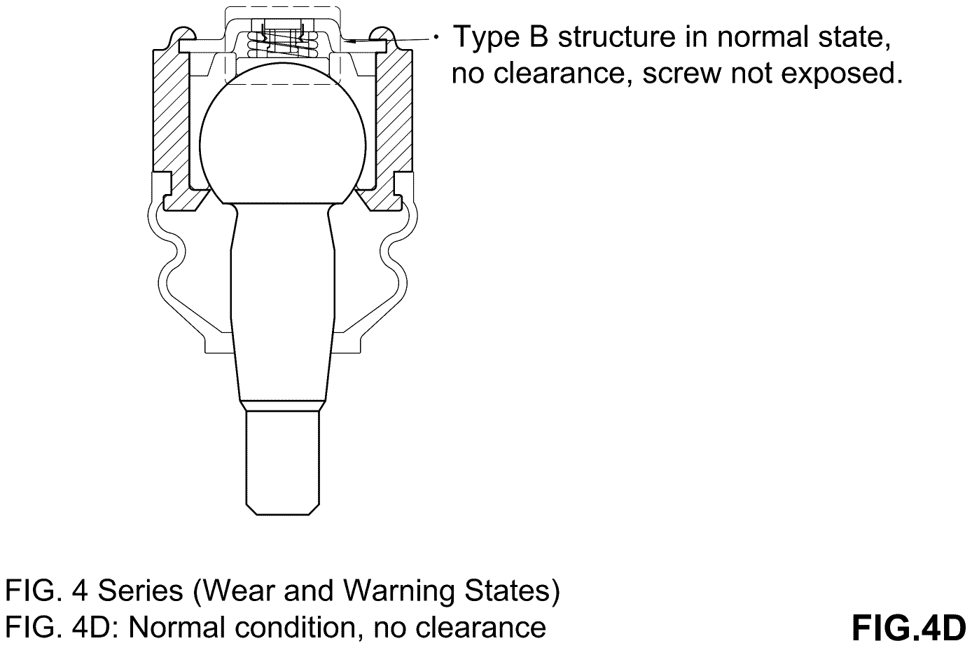

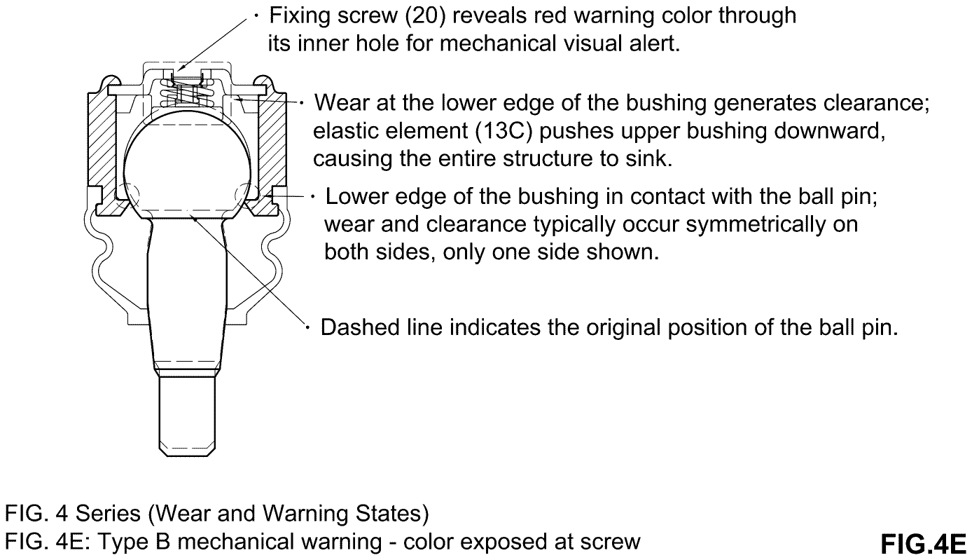

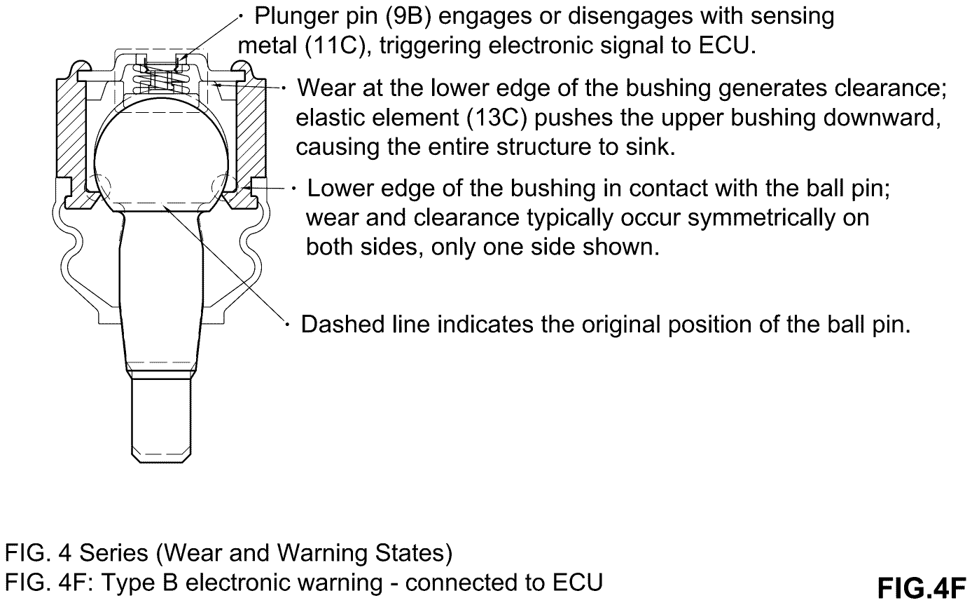

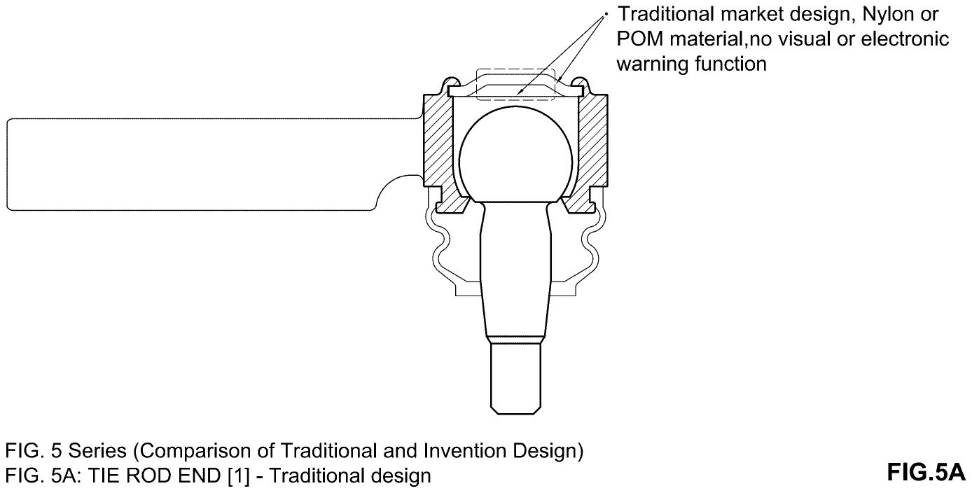

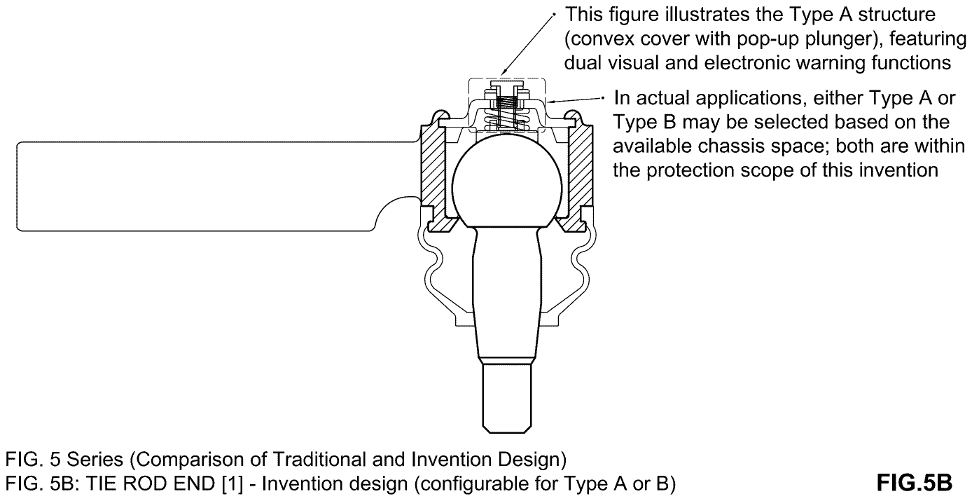

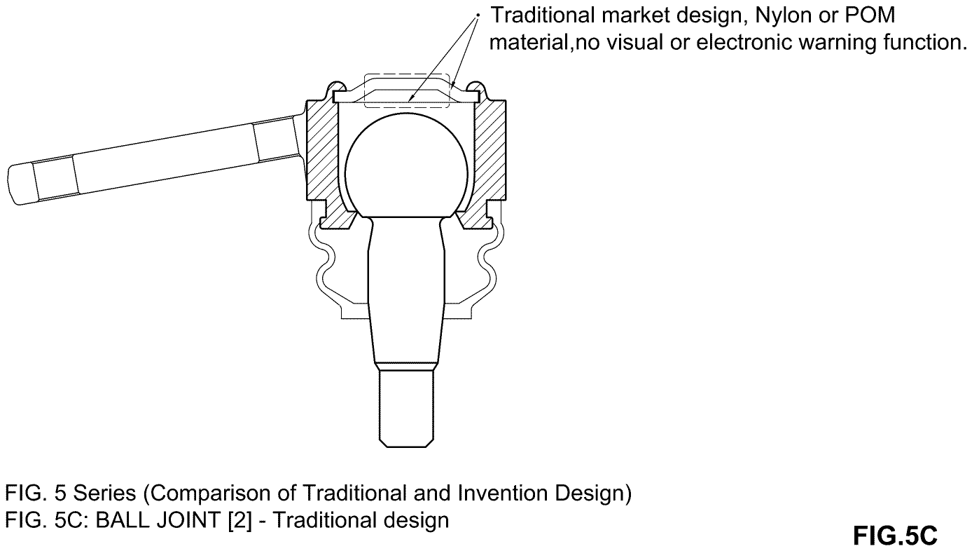

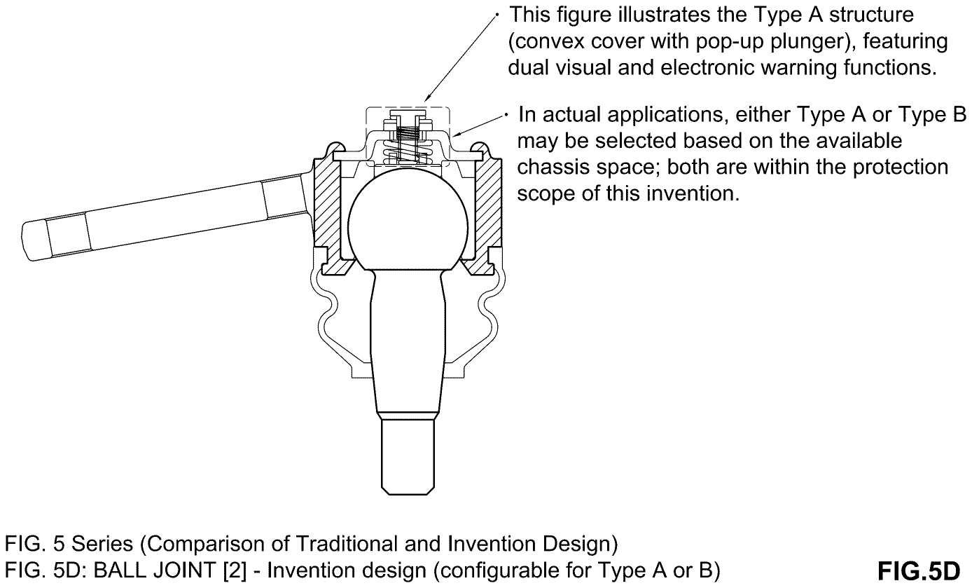

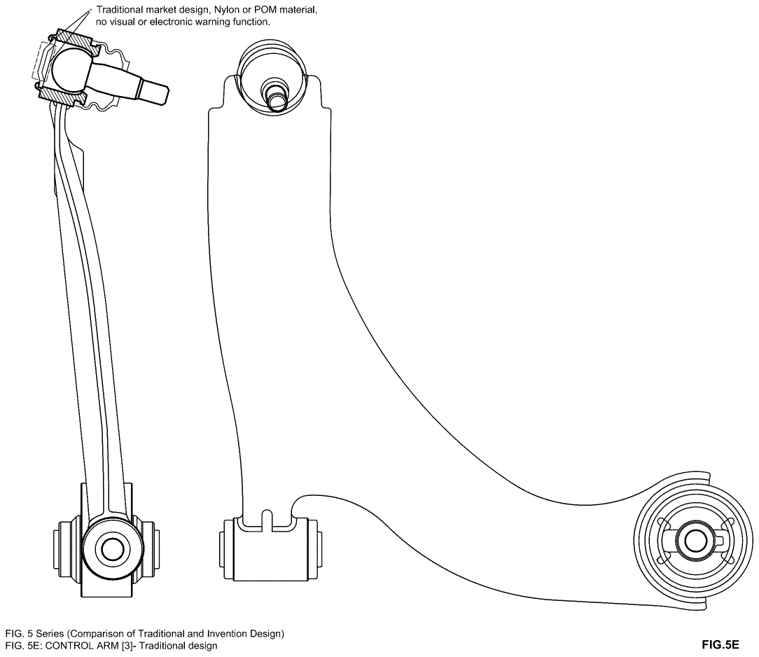

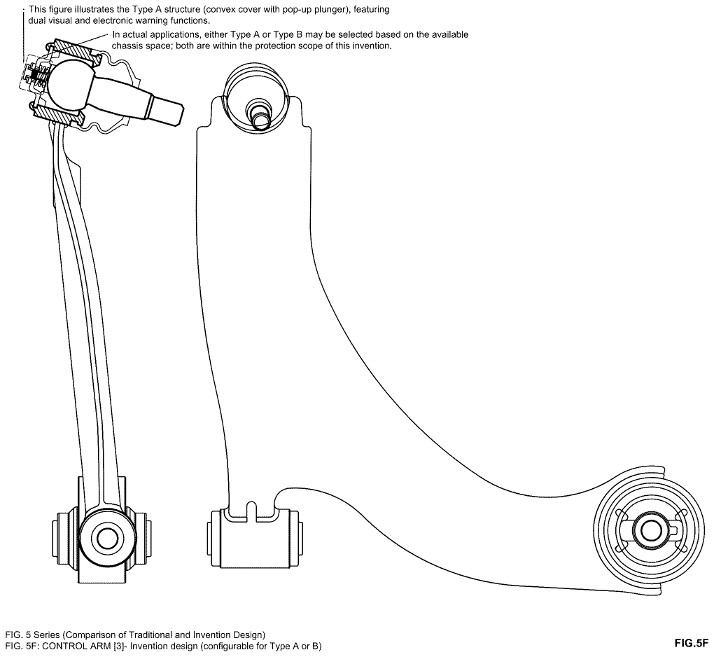

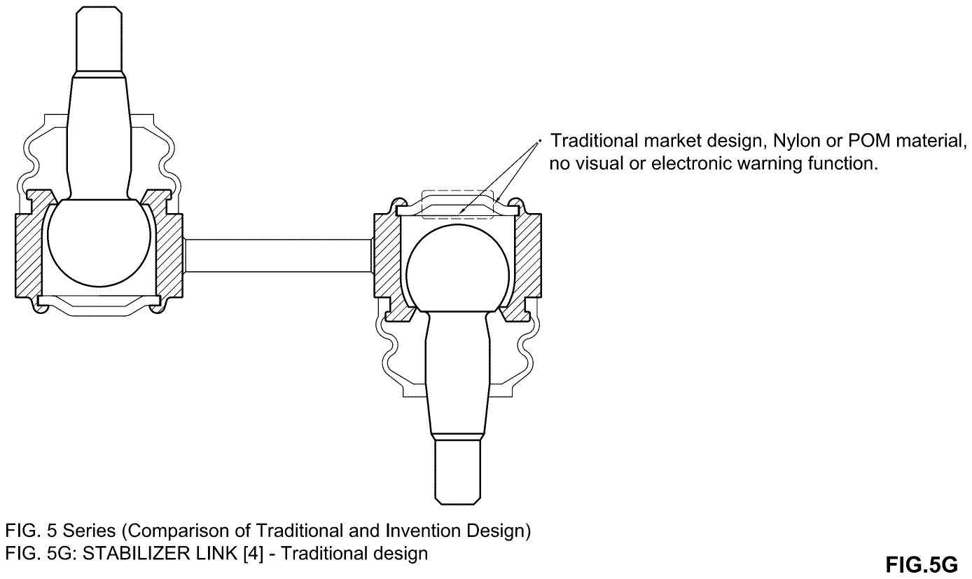

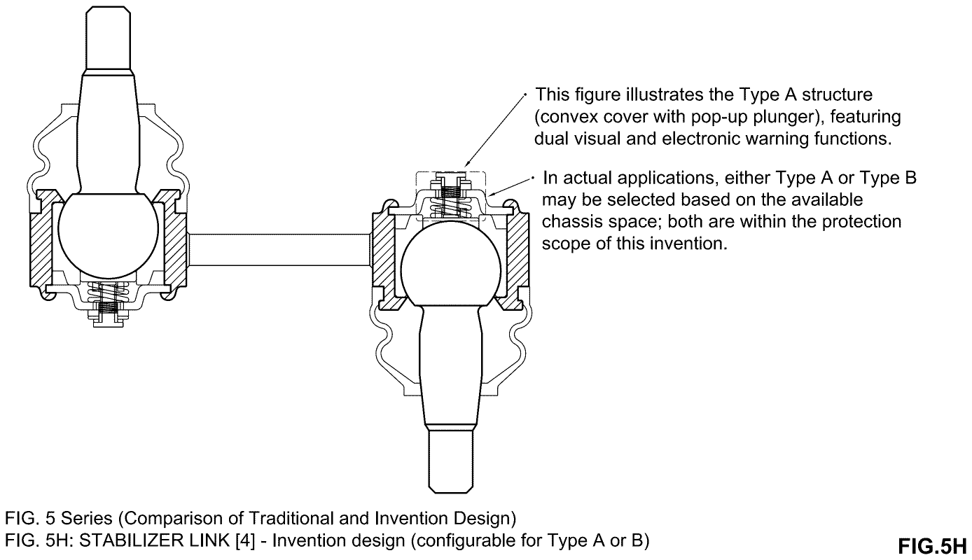

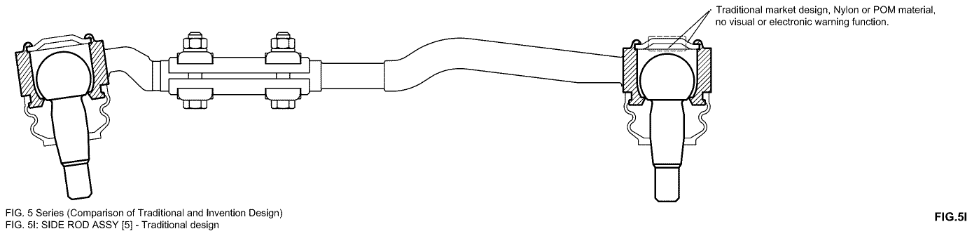

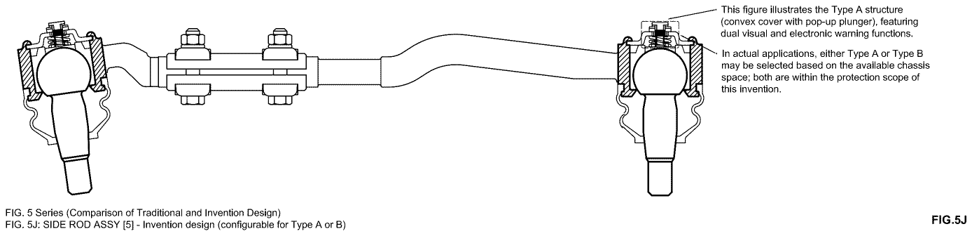

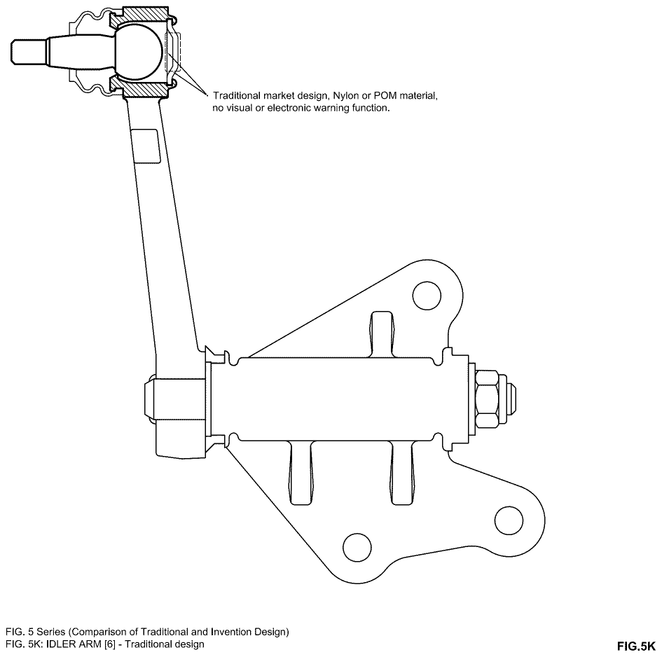

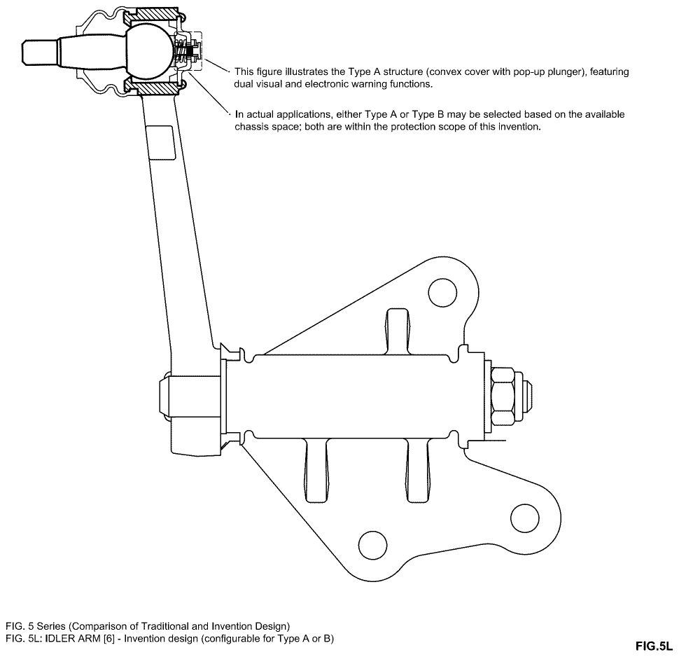

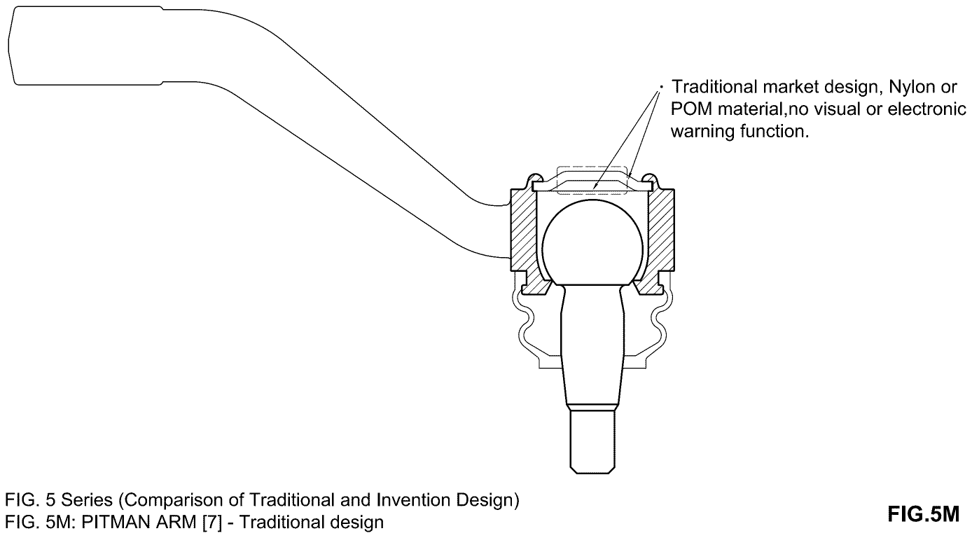

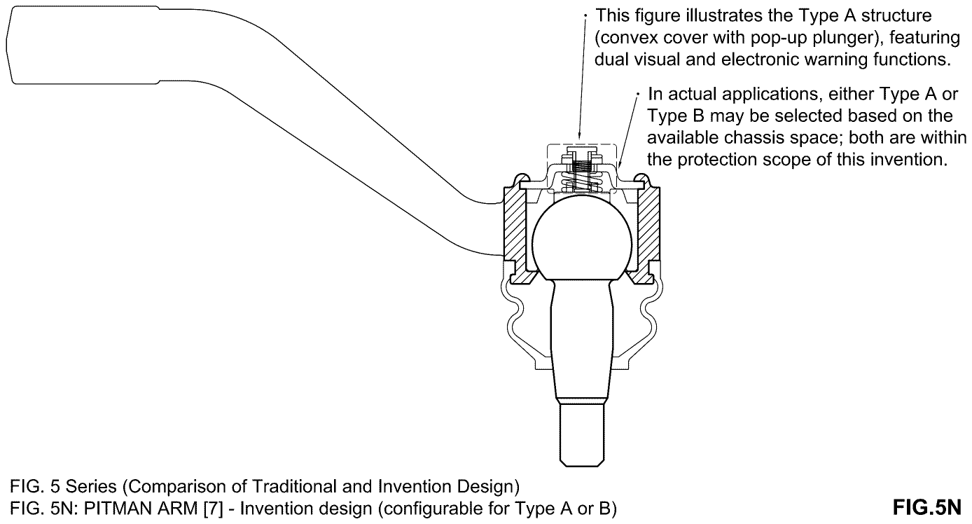

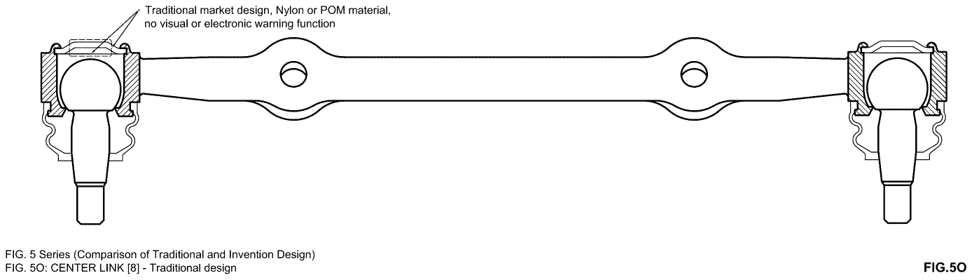

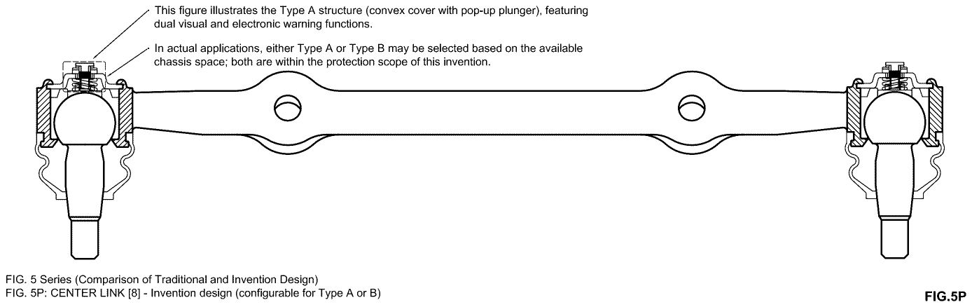

1. A high-durability and clearance monitoring steering component for a vehicle chassis, comprising:
a housing;
a Ball Pin received in the housing;
a bushing positioned between the housing and the Ball Pin, the bushing comprising left, right, and upper bushing sections, wherein lower inner edges of the left and right bushing sections define a contact area with the Ball Pin, and frictional wear at the contact area generates a wear-induced clearance, whereby support for the Ball Pin is reduced and the upper bushing section is displaced downward together with the Ball Pin;
an elastic element disposed above the upper bushing section and configured to continuously apply a downward preload to the upper bushing section, wherein the downward preload is present before the wear-induced clearance is generated, and wherein generation of the wear-induced clearance permits the downward preload to cause downward displacement of the upper bushing section;
a clearance-pressure monitoring device configured to be actuated by the downward displacement of the upper bushing section resulting from the wear-induced clearance;
wherein the clearance-pressure monitoring device comprises a mechanical warning mechanism and an electronic warning mechanism;
wherein the mechanical warning mechanism comprises a plunger pin movable relative to the bushing and the housing in response to actuation of the clearance-pressure monitoring device to provide a visible mechanical warning by protrusion or retraction of the plunger pin; and
wherein the electronic warning mechanism comprises at least one sensing metal configured to change an electrical contact state with the plunger pin in response to movement of the plunger pin, thereby generating an electronic warning signal configured to be transmitted to an electronic control unit (ECU).

2. The component of claim 1, wherein the bushing is made of a composite material comprising polyketone (POK) and fiberglass, thereby enhancing wear resistance, thermal stability, structural integrity, and operational lifespan.

3. The component of claim 1, wherein the mechanical warning mechanism comprises:
a Type A structure comprising a convex upper cover, the plunger pin, a plastic housing, and the elastic element of claim 1, wherein, when the wear-induced clearance actuates the clearance-pressure monitoring device, the plunger pin is pushed upward by the elastic element, causing the plastic housing to expose a color, thereby providing a mechanical visual warning;
a Type B structure comprising a convex or flat upper cover, a recessed plunger pin integrated with a plastic housing, a fixing screw, and the elastic element of claim 1, wherein, when the wear-induced clearance actuates the clearance-pressure monitoring device, the entire structure sinks, and the fixing screw exposes a color through its inner hole, thereby providing a mechanical visual warning.

4. The component of claim 1, wherein the electronic warning mechanism is activated by a change in physical connection or separation between the plunger pin and at least one sensing metal, thereby generating the electronic warning signal configured to be transmitted to an electronic control unit (ECU).

5. The component of any of the preceding claims, being applicable to all vehicles equipped with wheels and steering systems, including passenger vehicles, commercial vehicles, trucks, military vehicles, electric vehicles, construction vehicles, and forklifts; and applicable to chassis components including tie rod ends, ball joints, control arms, stabilizer links, side rod assemblies, idler arms, pitman arms, center links, cross rods, and drag links, and extendable to any chassis component possessing articulation, rotation, suspension, or directional control functions.

6. The component of claim 1, wherein the upper bushing and the left and right bushing sections are independently formed, and the upper bushing is displaced downward by the elastic element in response to the wear-induced clearance, whereby the downward displacement of the upper bushing actuates at least one of the mechanical warning mechanism and the electronic warning mechanism.
